(19) United States
(12) Patent Application Publication
(10) Pub. No.: US 2023/0408369 A1
(43) Pub. Date: Dec. 21, 2023

(54) OPTICAL TESTING DEVICE WITH LIGHT INTENSITY CHANGE DETECTING FUNCTION

(71) Applicant: Taiwan RedEye Biomedical Inc., Hsinchu City (TW)

(72) Inventor: Tsung-Jui LIN, Hsinchu City (TW)

(73) Assignee: Taiwan RedEye Biomedical Inc., Hsinchu City (TW)

(21) Appl. No.: 17/844,798

(22) Filed: Jun. 21, 2022

(51) Int. Cl. G01M 11/02; G02B 27/14; G01N 21/01

(52) U.S. Cl. CPC G01M 11/02; G02B 27/14; G01N 21/01

(57) ABSTRACT

An optical testing device has a beam splitting element, a glowing unit, a first sensor, and a second sensor. The beam splitting element has a first side and a second side. The glowing unit and the second sensor are disposed at the second side. The first sensor is disposed at the first side. The beam splitting element is capable of splitting the beam emitted from the glowing unit into a testing beam and a reflection beam. The testing beam penetrates the beam splitting element and is received by the first sensor. The reflection beam is reflected by the beam splitting element and is received by the second sensor. Therefore, the change of light intensity of the light source can be monitored, and thus the processing unit is allowed to correct the calculations on the basis of the change of light intensity of the light source.

### BACKGROUND OF THE INVENTION

### 1. Field of the Invention

The present invention relates to an optical testing device, especially to an optical testing device that has a function for detecting the change of light intensity of the light source and is capable of providing a reference light intensity of the light source.

### 2. Description of the Prior Arts

The operation of an optical detection device is as follows. A beam is emitted by a light source, penetrates a testing substance, and is received by a photoelectric sensor. Then, a processing unit calculates the change of the beam after penetrating the testing substance to test the testing substance.

However, if the light source is continuously turned on for a long time, there is a possibility of light decay, which means the light intensity of the light source will decrease, and such decrease may cause misjudgment of the processing unit and results in inconsistency between the testing result and the actual situation.

Therefore, the change of light intensity of the light source should be monitored. If the change of light intensity can be monitored in real time, a reference light intensity can be provided, and the processing unit is allowed to correct the calculations on the basis of the change of light intensity of the light source, so as to avoid the misjudgment caused by the change of light intensity of the light source.

To overcome the shortcomings, the present invention provides an optical testing device with a light intensity change detecting function to mitigate or obviate the aforementioned problems.

### SUMMARY OF THE INVENTION

The main objective of the present invention is to provide an optical testing device that has a second photoelectric sensor and a light source located in a same side of the beam splitting element, so that the change of light intensity of the light source can be monitored, and thus the processing unit is allowed to correct the calculations on the basis of the change of light intensity of the light source to avoid the misjudgment caused by the change of light intensity of the light source.

The optical testing device has a beam splitting element, a glowing unit, a first sensor, and a second sensor. The beam splitting element has a first side and a second side. The glowing unit is disposed at the second side of the beam splitting element and is capable of emitting a beam toward the beam splitting element. The first sensor is disposed at the first side of the beam splitting element. The second sensor is disposed at the second side of the beam splitting element. Wherein, the beam splitting element is capable of splitting the beam emitted from the glowing unit into a testing beam and a reflection beam. The testing beam penetrates the beam splitting element and is received by the first sensor. The reflection beam is reflected by the beam splitting element and is received by the second sensor.

The beneficial effects of the present invention are achieved by mounting a second sensor on the same side as the glowing unit and splitting the beam emitted from the glowing unit into two beam paths including a testing beam and a reflection beam by the beam splitting element. Specifically, the testing beam is capable of penetrating the beam splitting element and the testing substance and received by the first sensor to test the testing substance. The reflection beam is reflected by the beam splitting element and is received by the second sensor. Therefore, a beam emitted from the glowing unit can be directly received by the second sensor without penetrating any other substance, so that the second sensor can directly detect the change of light intensity of the light source so as to monitor the change of light intensity of the light source in real time. As a result, the processing unit is allowed to correct the calculations on the basis of the change of light intensity of the light source to avoid the misjudgment caused by the change of light intensity of the light source.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of an optical testing device in accordance with the present invention;

FIG. 2 is an exploded view of the first embodiment of the optical testing device in FIG. 1;

FIG. 3 is a perspective view in cross-section of the first embodiment of the optical testing device in FIG. 1;

FIG. 4 is a top view in cross-section of the first embodiment of the optical testing device in FIG. 1;

FIG. 5 is a schematic diagram of the first embodiment of the optical testing device in FIG. 1, showing the beam path;

FIG. 6 is a flow chart of the first embodiment of the optical testing device in FIG. 1, showing the first correcting mechanism;

FIG. 7 is another flow chart of the first embodiment of the optical testing device in FIG. 1, showing the second correcting mechanism;

FIG. 8 is an operational view of the first embodiment of the optical testing device in FIG. 1;

FIG. 9 is a perspective view of a second embodiment of the optical testing device in accordance with the present invention; and

FIG. 10 is a partial enlarged view of the second embodiment of the optical testing device in FIG. 9.

### DETAILED DESCRIPTION OF THE PREFERRED EMBODIMENTS

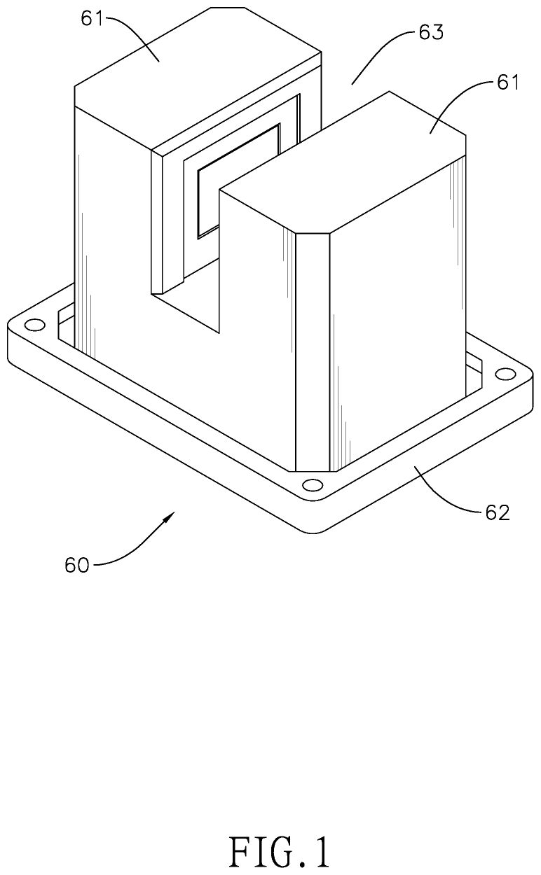

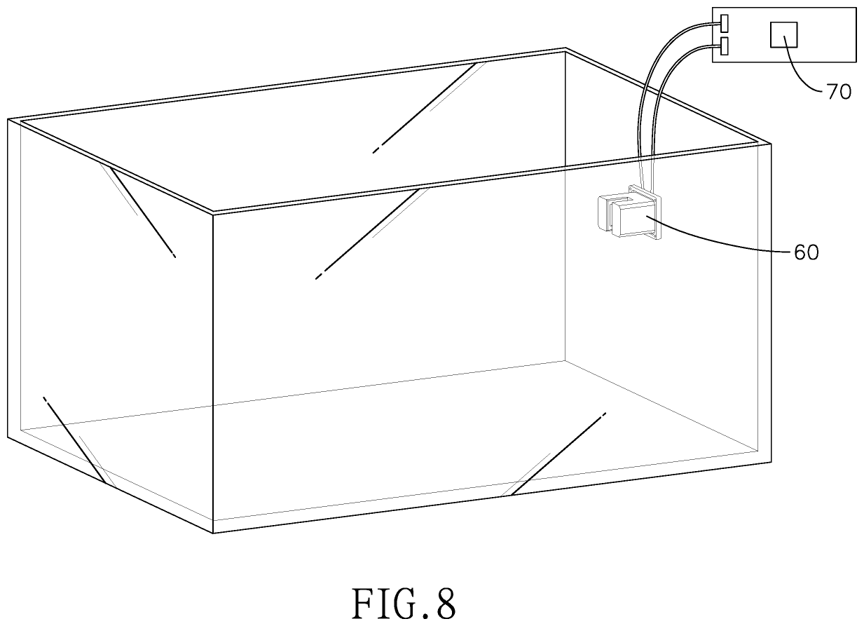

With reference to FIGS. 1, 2, and 8, an optical testing device in accordance with the present invention comprises a beam splitting element 10, a glowing unit 20, a first sensor 31, a second sensor 32, a carrier 40, two circuit boards 50, a case 60, and a processing unit 70.

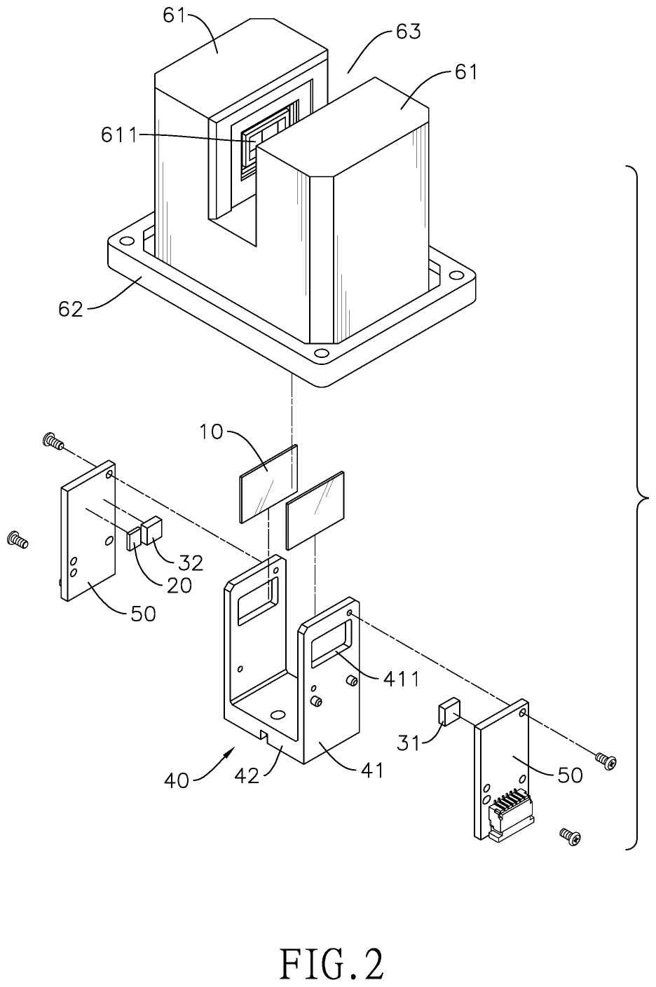

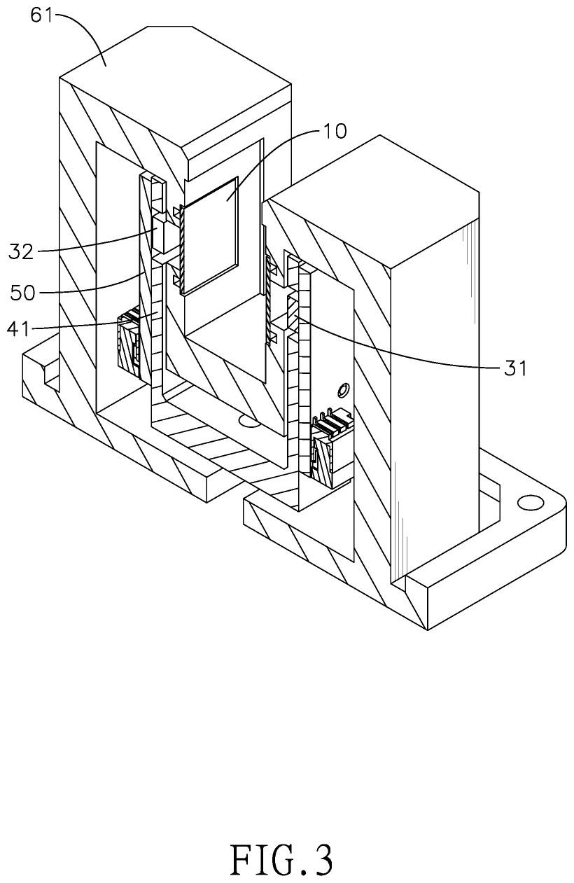

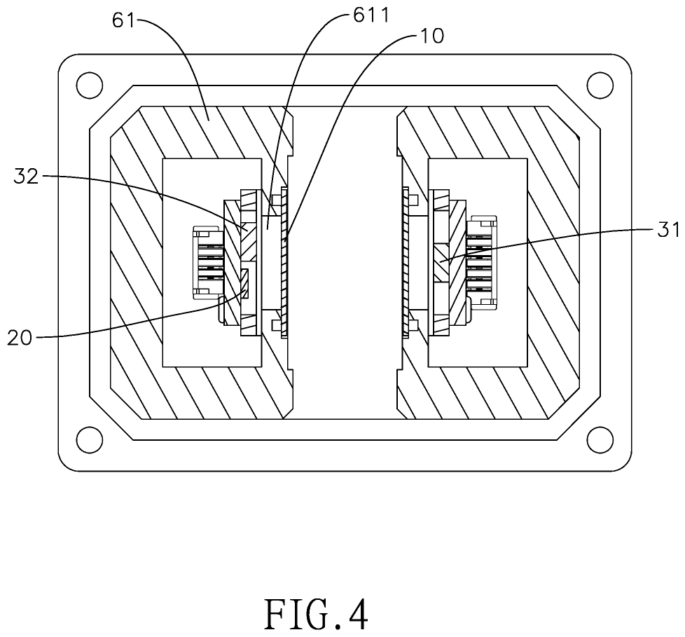

With reference to FIGS. 2, 3, 4, and 5, the beam splitting element 10 has a first side 11 and a second side 12. The glowing unit 20 is disposed at the second side 12 of the beam splitting element and is capable of emitting a beam 21 toward the beam splitting element 10. The first sensor 31 is disposed at the first side 11 of the beam splitting element 10. The second sensor 32 is disposed at the second side 12 of the beam splitting element. The beam splitting element is capable of splitting the beam 21 emitted from the glowing unit 10 into a testing beam 211 and a reflection beam 212. The testing beam 211 penetrates the beam splitting element 10 and is received by the first sensor 31. The reflection beam 212 is reflected by the beam splitting element 10 and is received by the second sensor 32.

By the abovementioned configuration, a path of the beam 21 is as follows. The glowing unit 20 emits the beam 21 toward the beam splitting element 10. The beam 21 hits the beam splitting element 10 and then is split into two beams. One of the two beams is a testing beam 211 sequentially penetrating the beam splitting element 10 and the testing substance A and then hitting the first sensor 31, so that the first sensor 31 can receive the testing beam 211 to run signal analysis. The other one of the two beams is a reflection beam 212 reflected by the beam splitting element 10 and then hitting the second sensor 32, so that the second sensor 32 can receive the reflection beam 212 to monitor the light intensity of the light source and to run correction mechanism.

After the second sensor 32 detects a change of a light intensity of the glowing unit 20, the processing unit 70 runs one of the two following mechanisms to correct testing results:

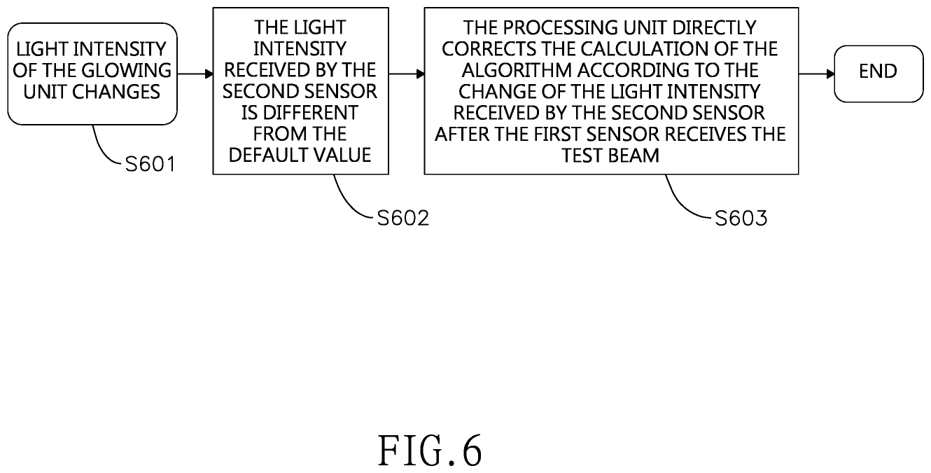

First, with reference to FIG. 6, as shown in step S601 to step S603, at the time the light intensity of the glowing unit 20 changes, the reflection beam 212 received by the second sensor 32 will directly reflect that the light intensity of the glowing unit 20 is different from the default value. Then, the processing unit 70 directly corrects the calculation of the algorithm according to the change of the light intensity received by the second sensor 32 after the first sensor 31 receives the test beam 211. That is, when the processing unit 70 determines that the difference between the light intensity signal generated by the second sensor 32 and the default value exceeds the first threshold value, the processing unit 70 runs an adjustment calculation on the detection signal received by the first sensor 31 according to the light intensity signal generated by the second sensor 32.

For example, if the second sensor 32 senses that the light intensity of the glowing unit 20 is only 70% of the default value, then after the first sensor 31 receives the testing beam 211, when calculating the change of the beam 21 after penetrating the testing substance A, the processing unit 70 corrects a light intensity of the glowing unit 20 before penetrating the testing substance A to 70% so as to exclude the attenuation of the light intensity of the glowing unit itself and to precisely determine the change of beam 21 before and after penetrating test substance A.

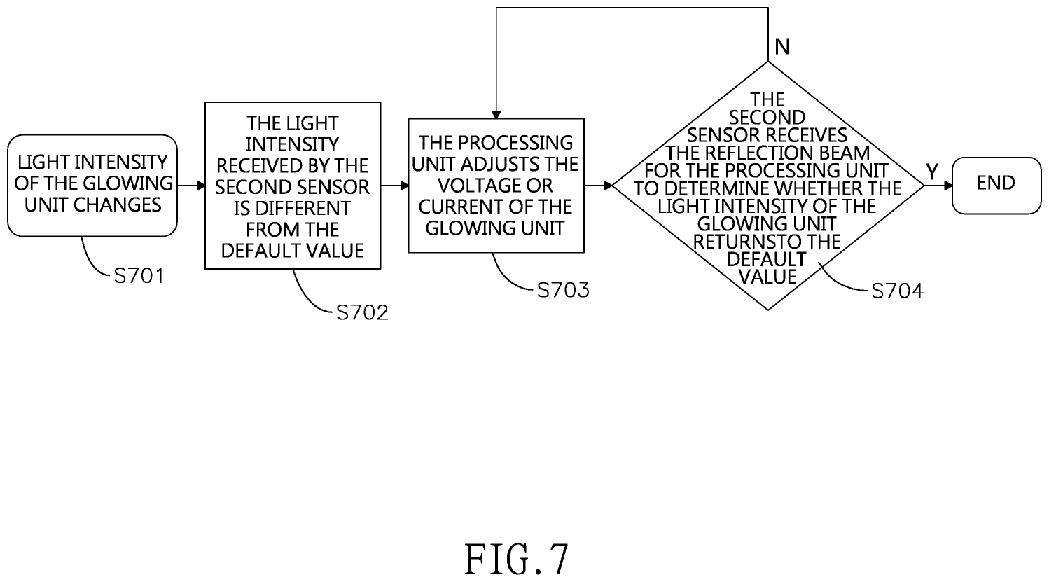

Second, with reference to FIG. 7, as shown in step S701 to step S704, at the time the light intensity of the glowing unit 20 changes, the reflection beam 212 received by the second sensor 32 will directly reflect that the light intensity of the glowing unit 20 is different from the default value. Then, the processing unit 70 adjusts the voltage or current of the glowing unit 20 to directly change the light intensity of the glowing unit 20. Simultaneously, the second sensor 32 receives the reflection beam 212 for the processing unit 70 to determine whether the light intensity of the glowing unit 20 returns to the default value by adjusting the voltage or current. The adjustment and the determination are run until the light intensity of the glowing unit 20 returns to the default value, and then the processing unit 70 runs the test. In other words, when the processing unit 70 determines that the difference between the light intensity signal generated by the second sensor 32 and the default value exceeds the second threshold value, the processing unit 70 adjusts the light intensity of the glowing unit 20 until the processing unit 70 determines that the difference between the light intensity signal generated by the second sensor 32 and the default value does not exceed the second threshold value, and then the processing unit 70 runs the test according to the detection signal received by the first sensor 31.

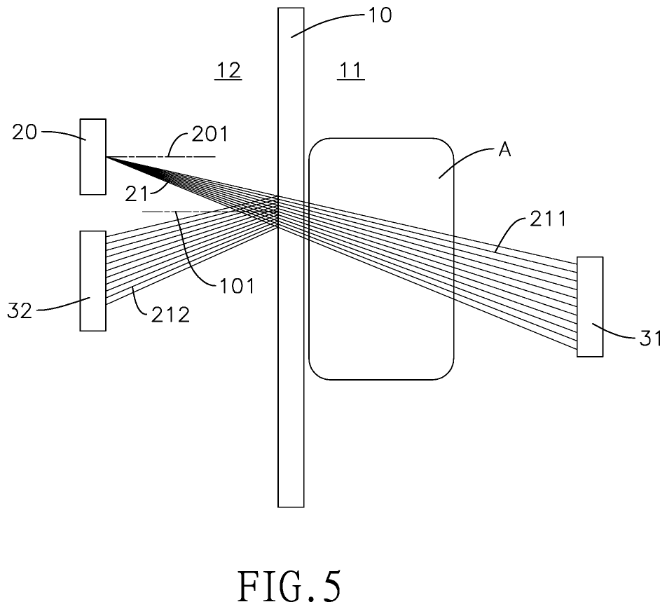

Additionally, with reference to FIG. 5, in the first embodiment, an optical axis 201 of the glowing unit 20 is parallel to an optical axis 101 of the beam splitting element 10. In other words, an axis of the beam 21 of the glowing unit 20 is parallel to a normal of the beam splitting element 10. By the optical axis 201 of the glowing unit 20 parallel to the optical axis 101 of the beam splitting element 10, after the beam 21 of the glowing unit 20 hits the beam splitting element 10, the direction of the reflection beam 212 is turned more than 90 degrees, and such an optical path is beneficial to volume reduction, so that the optical testing device in the present invention is allowed to be made into miniaturized detection devices or handheld detection devices of small volumes.

Moreover, the glowing unit 20 can be a halogen lamp, gas lamp, laser, light emitting diode (LED) or any other light emitting elements. The first sensor 31 and the second sensor 32 can be a photoelectric sensor (PD), a photoelectric sensor array (PD array), a spectrometer, a linear image sensor (CMOS sensor) or any other photosensitive elements. The beam splitting element 10 can be realized by coating, combination of dissimilar materials or any other beam splitting principles.

With reference to FIGS. 2, 3, and 4, the carrier 40 has two mounting segments 41 and a connecting segment 42. The two mounting segments 41 are spaced apart from each other. Two ends of the connecting segment 42 are respectively connected to the two mounting segments 41. The two circuit boards 50 are respectively mounted in the two mounting segments 41. The glowing unit 20 and the second sensor 32 are mounted on one of the two circuit boards 50. The first sensor 31 is mounted on the other one of the two circuit boards 50. Specifically, in the first embodiment, each one of the two circuit boards 50 is mounted on a side of the corresponding mounting segment 41, and the side of the corresponding mounting segment 41 is away from the other one of the two circuit boards 50. Each of the mounting segments 41 of the carrier has a hole 411. The glowing unit 20, the second sensor 32, and the first sensor 31 are respectively aligned to the hole 411 of the corresponding mounting segment 41, and are respectively located in the hole 411. The configuration of the two circuit boards 50 and the carrier 40 is not limited thereto, as the two circuit boards 50 can also be directly mounted on the case without the carrier 40.

With reference to FIGS. 2, 3, and 4, the case 60 has two accommodating segments 61 and a fixing segment 62. A testing space 63 is formed between the two accommodating segments 61. Each of the two accommodating segments 61 has a testing window 611 facing the testing space 63. The glowing unit 20, the second sensor 32 and the first sensor 31 are mounted in the case 60. The glowing unit 20 and the second sensor 32 are mounted in one of the two accommodating segments 61, and the first sensor 31 is mounted in the other one of the two accommodating segments 61. The glowing unit 20, the second sensor 32, and the first sensor 31 are respectively aligned to the testing window 611 of the corresponding accommodating segment 61. The beam splitting element 10 is mounted on the testing window 611 of one of the two accommodating segments 61. The fixing segment 62 is connected to the two accommodating segments 61 and is adapted for fixing.

The processing unit 70 is electrically connected to the glowing unit 20, the second sensor 32, and the first sensor 31. In the first embodiment, the processing unit 70 is, but not limited to, located outside the case 60.

With reference to FIGS. 1, 2, and 8, in the first embodiment, when the optical testing device is in use, the case 60 is fixed in an aquarium (testing tank) via the fixing segment 62, and the processing unit 70 is electrically connected to the glowing unit 20, the second sensor 32, and the first sensor 31 by wires penetrating a wall of the aquarium (testing tank). In other words, in the first embodiment, the optical testing device is a fixed testing device connecting to a computer via a transmission interface such as universal serial bus (USB) and using the computer's processor or software as the processing unit 70 for testing. Therefore, the first embodiment of the present invention is suitable for water quality testing, is capable of monitoring the water quality changes in the aquarium for a long time, and is adapted for long-term testing in various liquid tanks.

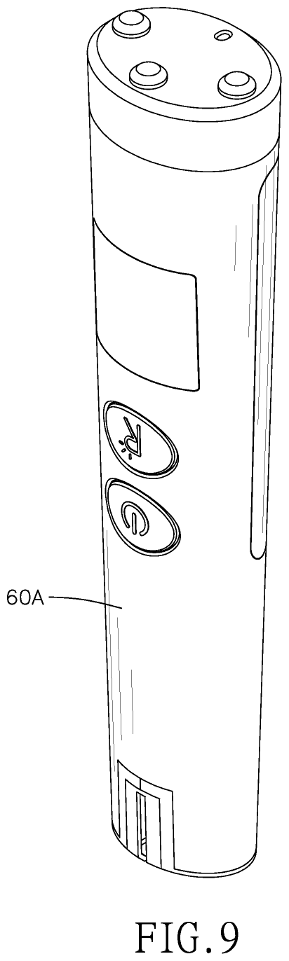

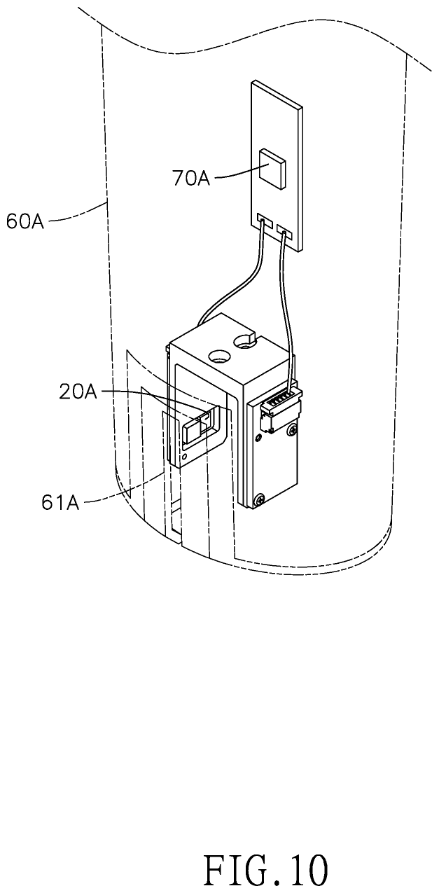

But the use of the optical testing device is not limited thereto. With reference to FIGS. 9 and 10, the structure of a second embodiment of the present invention is basically the same as the first embodiment, but only differs in the case 60. Specifically, in the second embodiment, the case 60A is columnar with a testing hole 61A formed on one end, and the components such as the processing unit 70A and the glowing unit 20A are installed in the case 60A. Therefore, the second embodiment can be used as a hand-held portable testing device which has its own processing unit, and directly runs the testing program and the adjustment mechanism of the light intensity change of the glowing unit 20A.

The beneficial effects of the present invention are achieved by mounting a second sensor 32 on the same side as the glowing unit 20 and splitting the beam 21 emitted from the glowing unit 20 into two beam paths including a testing beam 211 and a reflection beam 212 by the beam splitting element 10. Specifically, the testing beam 211 is capable of penetrating the beam splitting element 10 and the testing substance A and received by the first sensor 31 to test the testing substance A. The reflection beam 212 is reflected by the beam splitting element 10 and is received by the second sensor 32. Therefore, a beam emitted from the glowing unit 20 can be directly received by the second sensor 32 without penetrating any other substance, so that the second sensor 32 can directly detect the change of light intensity of the light source so as to monitor the change of light intensity of the light source in real time. As a result, the processing unit 70 is allowed to correct the calculations on the basis of the change of light intensity of the light source to avoid the misjudgment caused by the change of light intensity of the light source.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An optical testing device comprising:
a beam splitting element having
a first side; and
a second side;
a glowing unit disposed at the second side of the beam splitting element and capable of emitting a beam toward the beam splitting element;
a first sensor disposed at the first side of the beam splitting element;
a second sensor disposed at the second side of the beam splitting element;
wherein, the beam splitting element is capable of splitting the beam emitted from the glowing unit into a testing beam and a reflection beam; the testing beam penetrates the beam splitting element and is received by the first sensor; the reflection beam is reflected by the beam splitting element and is received by the second sensor.

2. The optical testing device as claimed in claim 1, wherein an optical axis of the glowing unit is parallel to an optical axis of the beam splitting element.

3. The optical testing device as claimed in claim 1, wherein the optical testing device has
a carrier having
two mounting segments spaced apart from each other;
a connecting segment having two ends respectively connected to the two mounting segments;
two circuit boards respectively mounted on the two mounting segments; the glowing unit and the second sensor mounted on one of the two circuit boards; the first sensor mounted on the other of the two circuit boards.

4. The optical testing device as claimed in claim 2, wherein the optical testing device has
a carrier having
two mounting segments spaced apart from each other;
a connecting segment having two ends respectively connected to the two mounting segments;
two circuit boards respectively mounted on the two mounting segments; the glowing unit and the second sensor mounted on one of the two circuit boards; the first sensor mounted on the other of the two circuit boards.

5. The optical testing device as claimed in claim 3, wherein
each one of the circuit boards is mounted on a side of the corresponding mounting segment, the side of the corresponding mounting segment being away from the other of the two circuit boards;
each of the two mounting segments of the carrier has a hole; and
each of the glowing unit, the second sensor, and the first sensor is aligned to the hole of the mounting segment on which the corresponding circuit board is mounted.

6. The optical testing device as claimed in claim 4, wherein
each one of the circuit boards is mounted on a side of the corresponding mounting segment, the side of the corresponding mounting segment being away from the other of the two circuit boards;
each of the two mounting segments of the carrier has a hole; and
each of the glowing unit, the second sensor, and the first sensor is aligned to the hole of the mounting segment on which the corresponding circuit board is mounted.

7. The optical testing device as claimed in claim 1, wherein the optical testing device has
a case having
two accommodating segments; a testing space formed between the two accommodating segments; each of the two accommodating segments having a testing window facing the testing space; the glowing unit and the second sensor mounted in one of the two accommodating segments and aligned to the testing window; the first sensor mounted in the other of the two accommodating segments and aligned to the testing window; the beam splitting element mounted on the testing window of one of the two accommodating segments; and
a fixing segment connected to the two accommodating segments and adapted for fixing.

8. The optical testing device as claimed in claim 6, wherein the optical testing device has
a case having
two accommodating segments; a testing space formed between the two accommodating segments; each of the two accommodating segments having a testing window facing the testing space; the glowing unit and the second sensor mounted in one of the two accommodating segments and aligned to the testing window; the first sensor mounted in the other of the two accommodating segments and aligned to the testing window; the beam splitting element mounted on the testing window of one of the two accommodating segments; and
a fixing segment connected to the two accommodating segments and adapted for fixing.

9. The optical testing device as claimed in claim 1, wherein the optical testing device has
a case; the glowing unit, the second sensor, and the first sensor mounted in the case; and
a processing unit located outside the case and electrically connected to the glowing unit, the second sensor and the first sensor.

10. The optical testing device as claimed in claim 8, wherein the optical testing device has
a case; the glowing unit, the second sensor, and the first sensor mounted in the case; and
a processing unit located outside the case and electrically connected to the glowing unit, the second sensor and the first sensor.

11. The optical testing device as claimed in claim 9, wherein
when the processing unit determines that a difference between a light intensity signal generated by the second sensor and a default value exceeds a first threshold value, the processing unit proceeds a correcting calculation to a detection signal received by the first sensor according to the light intensity signal.

12. The optical testing device as claimed in claim 10, wherein
when the processing unit determines that a difference between a light intensity signal generated by the second sensor and a default value exceeds a first threshold value, the processing unit proceeds a correcting calculation to a detection signal received by the first sensor according to the light intensity signal.

13. The optical testing device as claimed in claim 9, wherein
when the processing unit determines that a difference between a light intensity signal generated by the second sensor and a default value exceeds a second threshold value, the processing unit adjusts a light intensity of the glowing unit until the processing unit determines that the difference between the light intensity signal generated by the second sensor and the default value does not exceed the second threshold value, and then the processing unit proceeds a test according to a detection signal received by the first sensor.

14. The optical testing device as claimed in claim 10, wherein
when the processing unit determines that a difference between a light intensity signal generated by the second sensor and a default value exceeds a second threshold value, the processing unit adjusts a light intensity of the glowing unit until the processing unit determines that the difference between the light intensity signal generated by the second sensor and the default value does not exceed the second threshold value, and then the processing unit proceeds a test according to a detection signal received by the first sensor.
